(19) United States
(12) Patent Application Publication
(10) Pub. No.: US 2024/0056321 A1
(43) Pub. Date: Feb. 15, 2024

(54) DYNAMIC MEMBERSHIP FOR AN APPLICATION GROUP IN A MOBILE COMMUNICATION SYSTEM

(71) Applicant: Telefonaktiebolaget LM Ericsson (publ), Stockholm (SE)

(72) Inventors: Wenliang Xu, Shanghai (CN); Fuencisla Garcia Azorero, Madrid (ES); Susana Fernandez Alonso, Madrid (ES)

(21) Appl. No.: 18/266,872

(22) PCT Filed: Dec. 18, 2020
(86) PCT No.: PCT/CN2020/137661

§ 371 Date: Jun. 13, 2023

(51) Int. Cl. H04L 12/14; H04L 67/14

(52) U.S. Cl. CPC H04L 12/1407; H04L 67/14

(57) ABSTRACT

The embodiments herein relate to methods, network functions, and computer readable medium for handling dynamic group membership for an application group in a mobile communication system. In one embodiment, there proposes a method performed by a network function implementing a policy control function, comprising: receiving, from a network function implementing a terminal management function and/or a network function implementing a data repository function, a notification message indicating one or more changed application groups, wherein the notification message comprises one or more internal group identifiers each of which identifies respective one of the one or more changed application groups. With embodiments herein, it enables the PCF to properly handle all the service procedures that are related to the UE subscription to respective application groups.

### TECHNICAL FIELD

The embodiments herein relate generally to the field of mobile communication, and more particularly, the embodiments herein relate to methods, network functions, and computer readable medium for handling dynamic group membership for an application group in a mobile communication system.

### BACKGROUND

The third Generation Partnership Project (3GPP) defines a policy control architecture that allows handling Policy and Charging Control (PCC) in the network. This architecture is defined in both 3GPP Technical Specification (TS) 23.503 (5GS) and 3GPP TS 23.203 (Evolved Packet System, EPS).

The Policy Control Function (PCF) is a functional element that encompasses policy control decision and flow based charging control functionalities. The PCF provides network control regarding the service data flow detection, gating, Quality of Service (QoS) and flow based charging (except credit management) towards the Session Management Function (SMF). The PCF receives session and media related information from the Application Function (AF) and informs the AF of traffic plane events.

The PCF shall provision PCC Rules to the SMF via the N7 reference point. The PCF shall inform the SMF through the use of PCC rules on the treatment of each service data flow that is under PCC control, in accordance with the PCF policy decision(s).

The PCF provides UE policies, including Access Network Discovery and Selection Policy (ANDSP), UE Route Selection Policy (URSP), Vehicle-to-Everything Policy (V2XP) via the AMF (N15 interface) transparently to the UE.

The SMF or User Plane Function (UPF) encompasses service data flow detection based on the filters definitions included in the PCC rules and policy enforcement.

The Access and Mobility Management Function (AMF) is involved in registration management, connection management, reachability management and mobility management. It forwards the UE policies towards the served UE and reports the UE state to the PCF.

5G Group

For 3GPP Release 15 (Rel-15), it did not define any procedure to manage the UE membership to a group. For PCC, it was assumed that the list of groups a UE belongs to does not change, or at least it was unspecified how the 5GC should behave in case of change of the list of 5G groups.

For 3GPP Release 16 (Rel-16), specific groups are defined, e.g. the 5G Virtual Network (VN) Groups (defined in 3GPP TS 23.501, clause 5.29.2), which specifically required 5GC capabilities to dynamically handle both the 5G VN Group configuration data and the UE membership to a 5G VN Group.

But there are still Rel-15 groups (the ones used for e.g. to identify the target UEs that would be involved in AF influence on traffic routing), and new Rel-16 groups (as e.g. the ones for future background data transfer policies, IPTV services) whose dynamic group membership is still unspecified.

5G VN Groups

The 5G VN Groups are defined in 3GPP TS 23.501, clause 5.29.2 as follows:

“5G System supports management of 5G VN Group identification and membership (i.e. definition of 5G VN group identifiers and membership) and 5G VN Group data (i.e. definition of 5G VN group data). The 5G VN Group management can be configured by a network administrator or can be managed dynamically by AF.”

When the configuration is dynamically handled by the AF, for 5G VN Groups, the procedure is as follows:
The Network Exposure Functionality (NEF) provides the External Group ID, 5G VN group membership information and 5G VN group data to the Unified Data Management (UDM);
The UDM updates the Internal Group ID-list of the corresponding UE's subscription data in Unified Data Repository (UDR), if needed;
The UDM updates the Group Identifier translation in the Group Subscription data with the Internal Group ID, External Group ID and list of group members, if needed;
The UDM stores/updates the 5G VN group data (PDU session type, DNN and S-NSSAI, Application descriptor, Information related with secondary authentication/authorization) in UDR.

Service Parameter Provisioning

Service parameter provisioning is specified in 3GPP TS 23.502, clause 4.15.6.7. Service parameters consist of specific information to support the specific service in 5G system.

This service is used to manage 5G VN Groups.

The provisioning of this specific information may apply to individual UEs, a group of UEs or any UE.

Other AF Services that Indicate a Target Group of Users

There are other services apart of Service Parameter Provisioning whose specific service parameters are dynamically handled by the AF via specific service Application Programming Interfaces (APIs) (referred as Northbound APIs herein), and whose target can also be a group of users, as e.g., AF influence on traffic routing (3GPP TS 23.501, clause 5.6.7), negotiation for future Background Data Transfer (3GPP TS 23.503, clause 6.1.2.4), or IPTV configuration services (3GPP TS 23.316, clause 8.5).

### REFERENCES

3GPP TS 23.503 Rel 16
3GPP TS 23.501 Rel 16
3GPP TS 23.502 Rel 16
3GPP TS 23.316 Rel 16
3GPP TS 29.519 Rel 16
3GPP TS 29.512 Rel 16
3GPP TS 29.507 Rel 16
3GPP TS 29.525 Rel 16
3GPP TS 29.522 Rel 16.

### SUMMARY

In view of above problems and deficiencies, the embodiments herein propose to methods, network functions, and computer readable medium for handling dynamic group membership for an application group in a mobile communication system.

Generally, in order to solve the PCF awareness about the changes in the list of group Ids of a UE, there proposes the following approaches:
The AMF/SMF report of changes of group identifiers (IDs or Ids) to the PCF. The AMF/SMF shall report to the PCF the new list of groups when they receive from UDM an indication of group Id change.
The PCF subscription to AMF/SMF subscription data in UDR for notification of changes in the subscribed list of group ids for the UE.

Furthermore, regarding the support within the Northbound APIs designed for the purpose of service parameter provisioning scenarios, AF influence on traffic routing, IPTV configuration, Background data transfer, etc, of dynamic group membership management, there proposes the following approaches.

The AF can indicate, at Nnef_ParameterProvisioning service request, the group membership for the indicated groups and services (AF influence, IPTV, etc.).

The NEF, once it receives the group membership information, determines that whether the group membership information will be controlled by the NEF itself or UDM according to the related AF service.
If the group membership is generic, i.e. applicable to UDM services (e.g. group of UEs that share common treatment for registration or session management services), the NEF shall indicate to UDM the list of Generic Public Subscription Identifier (GPSI), the External Group Id provided by the AF, and the Service to which this External Group Id relates. The UDM will create a new internal group-Id, if applicable, and will update the group Id list for each involved UE, if applicable.
If the group information is applicable only to policy management services (i.e., they do not require UDM control, e.g., group of UEs that share common policies for the handling of AF influence on traffic routing, background data services) and the group membership does not match the group membership of an existing group managed by UDM, the NEF shall create a new internal group-Id, shall map the received external Id into internal Ids (with the support of UDM) and shall update the group Id list for each involved UE in the corresponding Policy Data Resource.

In one embodiment, there proposes a method performed by a network function implementing a policy control function, comprising: receiving, from a network function implementing a terminal management function and/or a network function implementing a data repository function, a notification message indicating one or more changed application groups, wherein the notification message comprises one or more internal group identifiers each of which identifies respective one of the one or more changed application groups.

In another embodiment, there proposes a method performed by a network function implementing an application function, comprising: transmitting, to a network function implementing a network exposure function, a first request message for parameter provisioning, wherein the first request message comprises one or more external group identifiers each of which identifies an application group, and one or more first indicators each of which indicating an application service used by the application group.

In yet another embodiment, there proposes a method performed by a network function implementing a network exposure function, comprising: receiving, from a network function implementing an application function, a first request message for parameter provisioning, wherein the first request message comprises one or more external group identifiers each of which identifies an application group, and one or more first indicators each of which indicating an application service used by the application group; determining whether the application group is controlled by the network function implementing the network exposure function, or by a network function implementing a data management function; and in response to the determination that the application group is controlled by the network function implementing the network exposure function, transmitting, to a network function implementing a data repository function, a second request message, wherein the second request message comprises one or more internal group identifiers corresponding to the one or more external group identifiers respectively; or in response to the determination that the application group is controlled by the network function implementing the data management function, transmitting, to the network function implementing the data management function, a third request message for parameter provisioning, wherein the third request message comprises the one or more external group identifiers and the one or more first indicators.

In yet another embodiment, there proposes a method performed by a network function implementing a data management function, comprising: receiving, from a network function implementing a network exposure function, a first request message for parameter provisioning, wherein the first request message comprises one or more external group identifiers each of which identifies an application group, and one or more first indicators each of which indicating an application services used by the application group; and transmitting, to a network function implementing a data repository function, a second request message, wherein the second request message comprises one or more internal group identifiers corresponding to the one or more external group identifiers respectively.

In yet another embodiment, there proposes a method performed by a network function implementing a terminal management function, comprising: receiving, from a network function implementing a policy control function, a first subscribing request for subscribing changes in one or more internal group identifiers; and transmitting, to the network function implementing the policy control function, a first notification message comprising one or more internal group identifiers each of which identifies respective one of the one or more changed application groups.

In yet another embodiment, there proposes a method performed by a network function implementing a data repository function, comprising: receiving, from a network function implementing a policy control function, a subscribing request for subscribing changes in one or more internal group identifiers; and transmitting, to the network function implementing the policy control function, a notification message comprising one or more internal group identifiers each of which identifies respective one of the one or more changed application groups.

In yet another embodiment, there proposes a network function, comprising: at least one processor; and a non-transitory computer readable medium coupled to the at least one processor, the non-transitory computer readable medium contains instructions executable by the at least one processor, whereby the at least one processor is configured to perform any of the above methods.

In yet another embodiment, there proposes a computer readable medium comprising computer readable code, which when run on an apparatus, causes the apparatus to perform any of the above method.

In yet another embodiment, there proposes a computer program product comprising computer readable code, which when run on an apparatus, causes the apparatus to perform any of the above method.

In further embodiment, the one or more application services comprises at least one of: IPTV service; applied background data transfer for future Package Data Unit (PDU) sessions; AF influence on traffic routing; parameter provisioning; and vehicle to everything (V2X) services.

In yet further embodiment, the network function implementing the policy control function is Policy Control Function (PCF); the network function implementing the terminal management function is Session Management Function (SMF), or Access and Mobility Management Function (AMF); the network function implementing the data repository function is Unified Data Repository (UDR); the network function implementing the network exposure function is Network Exposure Function (NEF); the network function implementing the application function is Application Function (AF); or the network function implementing the data management function is Unified Data Management (UDM).

With embodiments herein, the solution of the present disclosure allows the operator to apply updated and valid policies for UEs making use of application services that require a common policy treatment to the UEs belonging to the same application group. That is, it enables that the PCF is aware of the group membership change (e.g., the changes of the group identifier list) for one or more UEs included in one or more application groups, which enables the PCF to properly handle all the service procedures that are related to the UE subscription to respective application groups. Further, it enables an AF to fully control the UE membership to the application groups for each application service.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing a general architecture of 5G, in which the embodiments herein can be implemented;

FIG. 2 is a schematic signaling chart showing the messages for notifying the PCF about the changed application group from SMF;

FIG. 3 is a schematic signaling chart showing the messages for notifying the PCF about the changed application group from UDR;

FIG. 4 is a schematic signaling chart showing the messages for parameter provisioning controlled by UDM;

FIG. 5 is a schematic signaling chart showing the messages for parameter provisioning controlled by NEF;

FIG. 6 is a schematic flow chart showing an example method in a network implementing a policy control function according to the embodiments herein;

FIG. 7 is a schematic flow chart showing an example method in a network implementing an application function according to the embodiments herein;

FIG. 8 is a schematic flow chart showing an example method in a network implementing a network exposure function according to the embodiments herein;

FIG. 9 is a schematic flow chart showing an example method in a network implementing a data management function according to the embodiments herein;

FIG. 10 is a schematic flow chart showing an example method in a network implementing a terminal management function according to the embodiments herein;

FIG. 11 is a schematic flow chart showing an example method in a network implementing a data repository function according to the embodiments herein;

FIG. 12 is a schematic block diagram showing an example network function, according to the embodiments herein;

FIG. 13 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in one embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

For the purpose of illustration, some details are set forth in the following description, so as to provide a thorough understanding of the disclosed embodiments. However, it will be apparent to those skilled in the art that the embodiments may be practiced without the specific details or by using equivalent configurations.

According to the current technical specification, 5G VN Groups specification covers:
The scenarios where the AF can dynamically create a 5G VN Group and dynamically change the 5G VN Group membership;
the corresponding enhancements in UDR to permanently store the group configuration data and group membership; and
the UDM enhancements to handle this information in UDR and to update the AMF and SMF accordingly.

However, it is not specified how to allow the PCF to be aware of the dynamic change of Group Membership, until the currently published specification. In other words, the PCF is unaware of the changes of the list of groups the UE belong to, and thus, is unable to properly handle the update of UE Route Selection Policy (URSP) rules with 5G VN Group information.

Furthermore, Northbound APIs designed for AF influence on traffic routing, IPTV configuration, negotiation of future background data transfer, etc. provide the network operator with information about the group ID that would enjoy the indicated service but don't handle group membership. It means that it is not possible to modify the member list for a group of users created in the context of those services.

In addition, even for the scenarios where the network operator is handling the group membership for these services, there is no mechanism that ensures that a change in the membership of an already defined group (or the definition of a new group) could have an effect on PCC 5GC procedures, because of the PCF unawareness of the changes in list of the group Ids of a UE. It means that the policies associated to the UEs whose conditions are being changed in those groups cannot be updated dynamically and thus would be executed according to wrong information.

In view of above problems and deficiencies, the embodiments herein propose to methods, network functions, and computer readable medium for handling dynamic group membership for an application group in a mobile communication system.

In this disclosure, the application scenarios of the embodiments herein may occur in 5G system, in which the network functions may be implemented as the Policy Control Function (PCF), the Session Management Function (SMF), the User Plane Function (UPF), the Access and Mobility Management Function (AMF), the Network Exposure Functionality (NEF), the Network Data Analytics Function (NWDAF), the Charging Function (CHF), the Application Function (AF), the Unified Data Management (UDM), or the Unified Data Repository (UDR), and etc.

It should be understood that, a network function can be implemented either as a network element on a dedicated hardware, as a software instance running on a dedicated hardware, or as a virtualised function instantiated on an appropriate platform, e.g. on a cloud infrastructure.

It should be understood that, the application scenarios of the embodiments herein may also occur in other current telecommunication systems, e.g., 4G system or EPS or future telecommunication systems, where the network functions may have the same or similar functionalities as the above network functions in 5GS. For example, the AMF in 5GS can be performed by the Mobility Management Entity (MME) which is responsible for NAS access control function in EPC; the SMF in 5GS can be performed by the MME, Serving Gate Way (SGW), and Public Data Network (PDN) Gate Way (PGW) which are responsible for session management function; the UDM can be performed by Home Subscriber Server (HSS) and the UDR can be performed by Subscription Profile Repository (SPR); the PCF can be performed by Policy and Charging Rules Function (PCRF); and the NEF can be performed by Service Capability Exposure Function (SCEF).

For simplicity purpose, the embodiments herein are based on 5G architecture. The embodiments herein are applicable to 4G (EPC) architecture as well.

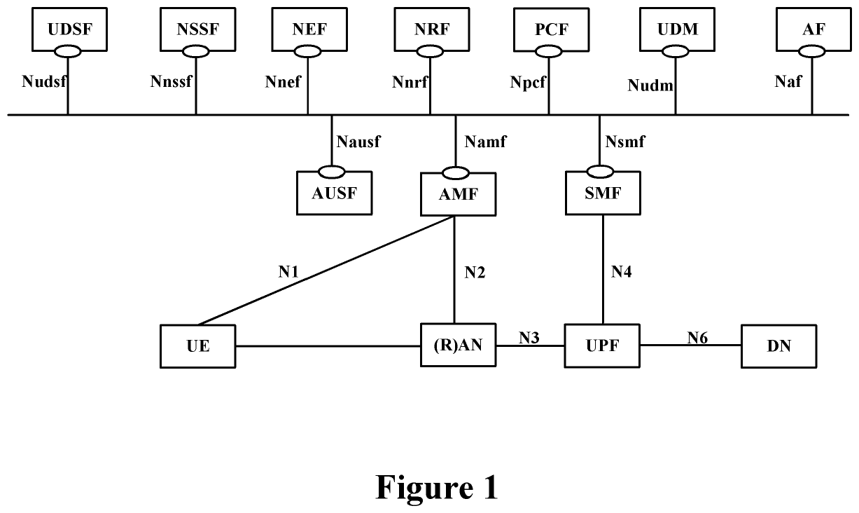

FIG. 1 is a schematic block diagram showing a general architecture of 5G, in which the embodiments herein can be implemented. The architecture may comprise the network functions including PCF, AF, SMF, AMF, NEF, UDM, and UDR.

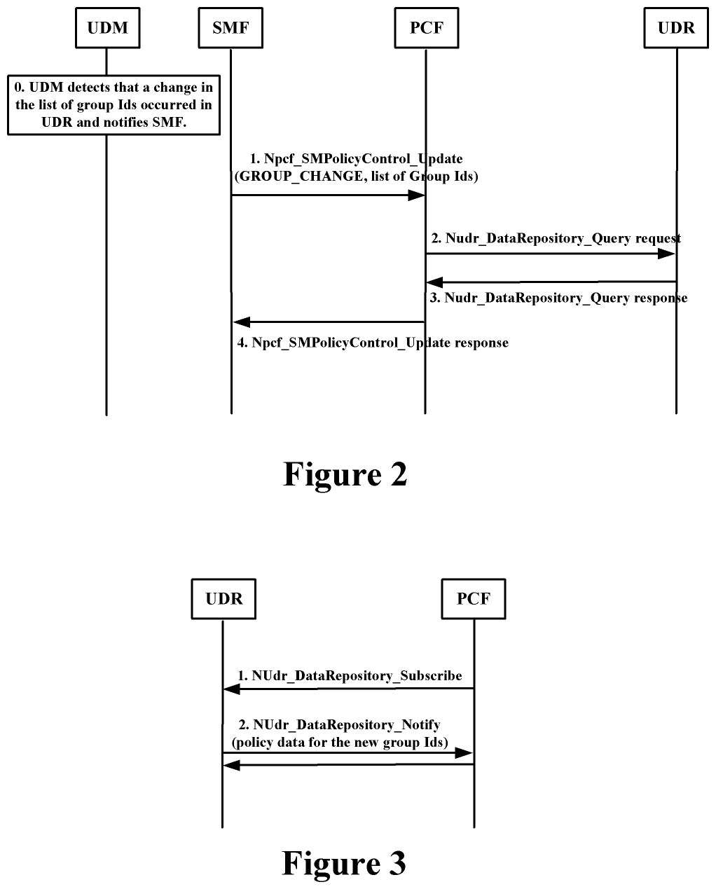

In some embodiments, the SMF/AMF may report changes of group Ids to the PCF. For example, the AMF/SMF shall report to the PCF the new list of groups when they receive from UDM a notification of change of the list of group Ids. To enable so, a policy control request trigger, GROUP_CHANGE, is defined for the Npcf_AMPolicyControl, Npcf_SMPolicyControl and Npcf_UEPolicyControl services. For deployments where the PCF is involved in the handling of group-based services and for UEs that are candidates to belong to a group for this kind of services, the PCF shall be always subscribed the GROUP_CHANGE policy control request trigger. When the SMF/AMF detects the change in the subscribed group Id list, the SMF/AMF notifies so to the PCF using the _Update service operation, such as Npcf_AMPolicyControl_Update, Npcf_SMPolicyControl_Update and Npcf_UEPolicyControl_Update. PCF will reevaluate policies accordingly. The detailed interaction flow is described with respect to FIG. 2.

In some embodiments, the PCF may subscribe to UDR, about notification of changes in the list of internal group Ids for a UE. The detailed interaction flow is described with respect to FIG. 3.

The embodiments herein also support AF indication of group membership for any service for which the Application enjoys service configuration, by using service parameter provisioning.

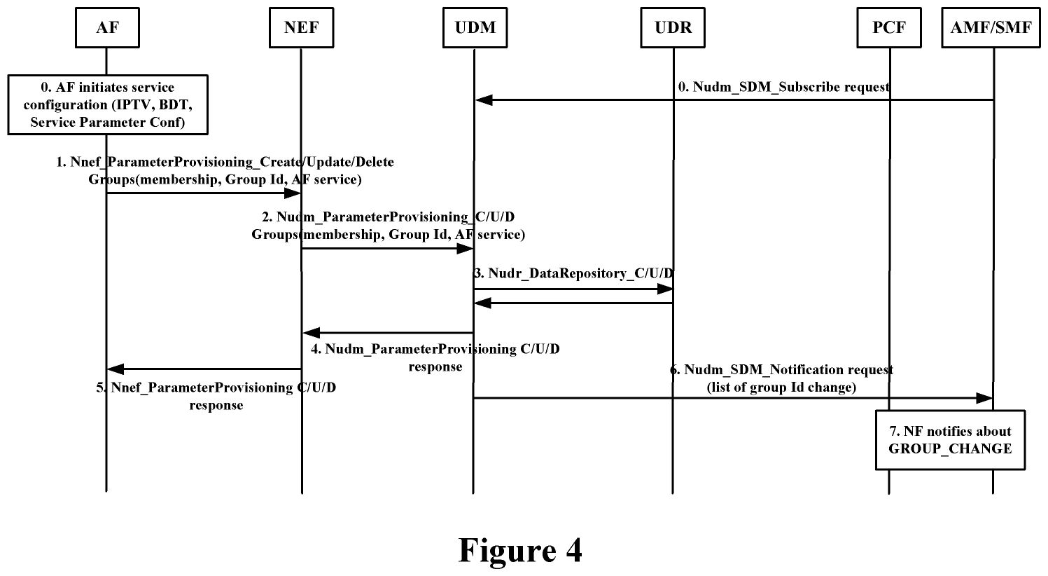

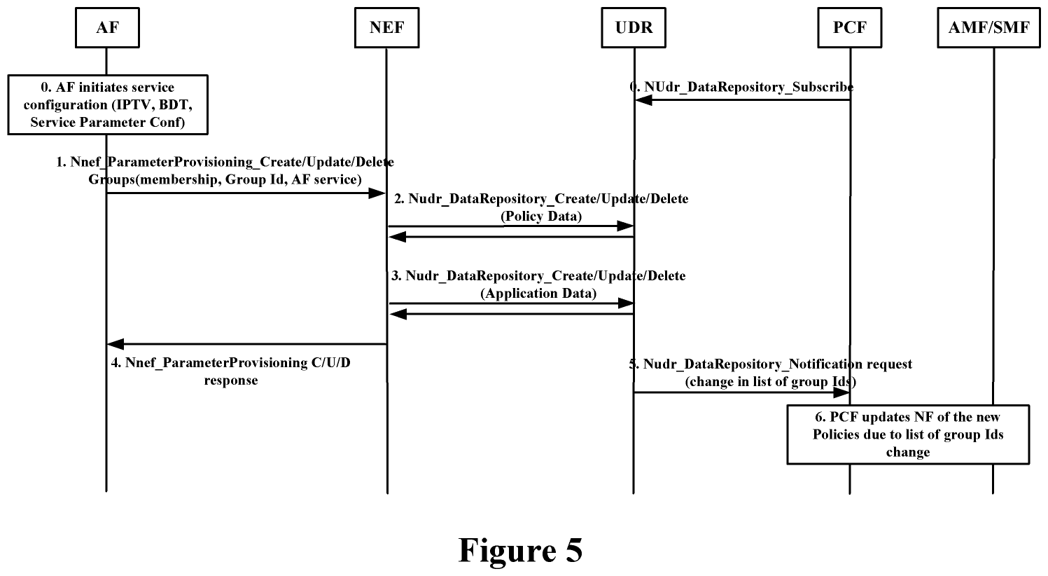

In some embodiments, the AF can indicate, within Nnef_ParameterProvisioning, the group membership for the indicated group and service. The NEF, once it receives the group membership information for the indicated group and service, determines that whether the group membership information will be controlled by the NEF itself or UDM according to the related AF service.
For subscription-based groups, i.e. if the group membership is controlled by UDM, the NEF shall indicate to UDM the list of GPSIs, the External Group Id and the related AF service. The UDM which will create a new internal group-Id, if required, and will update the group id list for each involved UE, if required. The detailed interaction flow is described with respect to FIG. 4.
If the group information is applicable only to policy management services, the NEF shall create a new internal group-Id, shall map the received external UE Id into internal UE Ids (with the support of UDM), shall store the group membership information within Application Data (External Group Id, Internal Group Id, group members (GPSIs)) and shall update the group Id list for each involved UE in the corresponding Policy Data Resource, if needed. The detailed interaction flow is described with respect to FIG. 5.

FIGS. 2-5 provide schematic signaling charts regarding how the network functions (e.g., PCF, AF, SMF, AMF, NEF, UDM, and UDR) interact with each other and handle the dynamic group membership for one or more UEs included in one or more application groups in 3GPP network.

Here, the term “application group” means a group comprising a plurality of UEs sharing the same application service. The term “application group” does not aim to include the 5G VN group. As an example, the application service may be IPTV service; applied background data transfer for future Package Data Unit (PDU) sessions; AF influence on traffic routing; parameter provisioning; and vehicle to everything (V2X) services.

FIG. 2 is a schematic signaling chart showing the messages for notifying the PCF about the changed application group from AMF/SMF. FIG. 2 shows an interaction flow between the UDM, SMF and PCF on UDM detection of change in the list of group Ids for Session Management.

Note that, similar equivalent interaction flow between the UDM, AMF and PCF would occur on UDM detection of change in the list of group Ids for Access and Mobility control may be also applicable. In this case, the Npcf_SMPolicyControl_Update request shown in FIG. 2 may be replaced with similar messages, such as Npcf_AMPolicyControl_Update or Npcf_UEPolicyControl_Update.

In order to make the notification for group change, the PCF may subscribe to the AMF/SMF about the application group change (e.g., change in the list of the group Ids for the UE and for the PDU session) in advance. The AMF/SMF may further subscribe to the UDM about the application group change.

The signaling chart may include the following messages or steps:

Step 0: When the UDM detects a change for the application group, for example, when the UDM detects a change in the list of group Ids occurred in UDR, the UDM will transmit a notification of group change (e.g., change in the list of the group Ids for the UE and for the PDU session) to the network function (e.g., AMF and/or SMF) which subscribes this group change. This step may be will further explained in more details with respect to Step 6 of FIG. 4.

Step 1: SMF, when receiving from the UDM a notification of application group change (e.g., change in the list of the group Ids for the UE and for the PDU session), notifies the PCF about this change. To do so, the SMF may invoke an Npcf_SMPolicyControl_Update request and includes the GROUP_CHANGE as policy control request trigger (which is described in 3GPP TS 23.503) together with the changed list of group Ids.

Here, the information element GROUP_CHANGE indicates the group change event triggered by SMF/AMF, and should be added in corresponding data model, such as Enumeration: PolicyControlRequestTrigger in 3GPP TS 29.512, clause 5.6.3.6; Enumeration: RequestTrigger in 3GPP TS 29.507, clause 5.6.3.3; and Enumeration: RequestTrigger in 3GPP TS 29.525, clause 5.6.3.3.

Step 2. When the PCF receives the notification regarding the updated list of group Ids, the PCF may retrieve from the UDR the available application data (e.g., the group data, the policy data, etc.) for the changed list of group Ids.

Step 3. The UDR responds with the available application data as requested by the PCF.

Step 4. The PCF changes the policy data in the SMF accordingly, for example:
The PCF removes from the SMF the policy data corresponding to the groups removed from the changed group Id list, for a UE;
The PCF creates in the SMF the policy data corresponding to the groups added to the changed group Id list, for a UE;
The PCF updates in the SMF the policy data corresponding to the changed groups in the changed group Id list, for a UE.

As may be understood, similar to SMF, the PCF may also change the policy data in the other network function such as AMF accordingly.

As may be understood, the term “group change” may include “adding a group”, “creating a group”, “updating a group”, “modifying a group”, “canceling a group”, “removing a group”, “deleting a group”, etc. That is, the term “group change” may include the following situations: one or more groups are created or deleted from the list of groups; one or more UEs are entering or leaving a particular group; and the UE members in the group remain unchanged while the application service for one or more existing UE members and/or the group Id are changed.

FIG. 3 is a schematic signaling chart showing the messages for notifying the PCF about the changed application group from UDR. The FIG. 3 shows an interaction flow between the UDR and PCF to enable the notification of changes in the list of group Ids for a UE stored, within the subscription data and/or policy data.

Here, the term “policy data” means the data related to a specific UE policy. For example, the policy data may comprise the data for Access Network Discovery and Selection Policy (ANDSP), the data for UE Route Selection Policy (URSP), the data for Vehicle-to-Everything Policy (V2XP), etc.

Here, the term “subscription data” means the data related to UE subscription, such as the UE subscription to respective application service.

As an example, the subscription data may include Access And Mobility Subscription Data and Session Management Subscription Data.

The signaling chart may include the following messages or steps:

Step 1. The PCF subscribes with UDR to notification of group changes in:
the attribute “internalGroupIds” of AccessAndMobilitySubscriptionData resource;
the attribute “internalGroupIds” of SessionManagementSubscriptionData resource; and/or
the attribute “internalGroupIds” of PolicyData, in the AccessAndMobilityPolicyData resource, SessionManagementPolicyData resource and UEPolicySet resource.

That is, in order to make the notification for group change, the PCF may subscribe to the UDR about the application group change. For example, the PCF may subscribe to the UDR about change in the list of the group Ids for the UE and for the PDU session, or PCF may subscribe to the UDR about the group data.

In one embodiment, one example of the AccessAndMobilityPolicyData resource is shown in the following table 1.

TABLE 1
an example of the definition of type AccessAndMobilityPolicyData

| Attribute name | Data type | P | Cardinality | Description |
|---|---|---|---|---|
| praInfos | map(PresenceInfo) | O | 1 . . . N | Presence reporting area information. Each PresenceInfo |
| | | | | element shall include the Presence Reporting Area Identifier |
| | | | | within the “praId” attribute and, for a UE-dedicated presence |
| | | | | reporting area, may also include the list of elements |
| | | | | composing the presence reporting area. |
| | | | | A “praId” may indicate a Presence Reporting Area Set. |
| | | | | The “praId” attribute within the PresenceInfo data type shall |
| | | | | also be the key of the map. |
| | | | | The attribute “presenceState” shall not be present. |
| subscCats | array(string) | O | 1 . . . N | List of categories associated with the subscriber |
| appIntGroupIds | array(GroupId) | O | 1 . . . N | List of application group Ids the UE belongs to |

In the above table 1, the information element “appIntGroupIds” in the AccessAndMobilityPolicyData may be used to indicate the internal group Id of the changed application group.

In another embodiment, one example of the SessionManagementPolicyData resource is shown in the following table 2.

TABLE 2
an example of the definition of type SessionManagementPolicyData

| | | | | | |
|---|---|---|---|---|---|
| Attribute name | Data type | P | Cardinality | Description | Applicability |

| | | | | |
|---|---|---|---|---|
| Snssai | Snssai | M | 1 | S-NSSAI associated with the data. |
| smPolicyDnnData | map(SmPolicyDnnData) | O | 1 . . . N | Session Management Policy data per |
| | | | | DNN for all the DNNs of the indicated |
| | | | | S-NSSAI. The key of the map is the |
| | | | | DNN. |
| appIntGroupIds | array(GroupId) | O | 1 . . . N | List of application group Ids the UE |
| | | | | belongs to |

In the above table 2, the information element “appIntGroupIds” in the SessionManagementPolicyData may be used to indicate the internal group Id of the changed application group.

In yet another embodiment, one example of the UEPolicySet resource is shown in the following table 3.

TABLE 3
an example of the definition of type UEPolicySet

| Attribute name | Data type | P | Cardinality | Description |
|---|---|---|---|---|
| praInfos | map(PresenceInfo) | O | 1 . . . N | Presence reporting area |
| | | | | information. Each PresenceInfo |
| | | | | element shall include the Presence |
| | | | | Reporting Area Identifier within the |
| | | | | “praId” attribute and, for a |
| | | | | UE-dedicated presence reporting |
| | | | | area, may also include the list of |
| | | | | elements composing the presence |
| | | | | reporting area. |
| | | | | A “praId” may indicate a Presence |
| | | | | Reporting Area Set. |
| | | | | The “praId” attribute within the |
| | | | | PresenceInfo data type shall also |
| | | | | be the key of the map. |
| | | | | The attribute “presenceState” shall |
| | | | | not be present. |
| subscCats | array(string) | O | 1 . . . N | List of categories associated with |
| | | | | the subscriber |
| appIntGroupIds | array(GroupId) | O | 1 . . . N | List of application group Ids the UE |
| | | | | belongs to |
| uePolicySections | map(UePolicySection) | O | 1 . . . N | Contains the UE Policy Sections. |
| | | | | The UPSI (UE Policy Section |
| | | | | Identifier) is used as the key in the |
| | | | | map. |
| Upsis | array(string) | O | 1 . . . N | List of identifiers for the |
| | | | | “uePolicySections”. The format of |
| | | | | the UPSI is represented in |
| | | | | 3GPP TS 24.501 [11] |
| | | | | subclause D.6.2 |
| allowedRouteSelDescs | map(PlmnRouteSelectionDescriptor) | O | 1 . . . N | Contains allowed route selection |
| | | | | descriptors per serving PLMN for a |
| | | | | UE. The serving PLMN identifier is |
| | | | | the key of the map. |
| andspInd | boolean | O | 0 . . . 1 | Indication of UE supporting |
| | | | | ANDSP. Default value is false. |
| Pei | Pei | O | 0 . . . 1 | Personal Equipment Identifier. |
| osIds | array(OsId) | O | 1 . . . N | Identification of the UE Operating |
| | | | | System(s). |
| suppFeat | SupportedFeatures | C | 0 . . . 1 | This IE represents a list of |
| | | | | Supported features used as |
| | | | | described in subclause 5.6. |
| | | | | This attribute shall be provided in |
| | | | | the PUT request and in the |
| | | | | response of successful resource |
| | | | | creation, and in the HTTP GET |
| | | | | response if the “supp-feat” |
| | | | | attribute query parameter is |
| | | | | included in the HTTP GET |
| | | | | request. (NOTE). |

(NOTE):
In the HTTP request, it represents the set of features supported by the NF service consumer. In the HTTP response, it represents the set of features supported by both the NF service consumer and the UDR.

In the above table 3, the information element “appIntGroupIds” in the UEPolicySet may be used to indicate the internal group Id of the changed application group.

Step 2. The UDR notifies the subscribed PCF of the application group change (such as the changed internal group Ids or the changed group data).

The UDR may invoke an Nudr_DataRepository_Notify to send the changed group Ids (changed list of Internal Group Ids) or the changed group data. Then, the PCF responds the UDR with a response message.

As may be understood, if the PCF receives the changed group Ids, similar to the FIG. 2, the PCF may retrieve from the UDR the available application data (e.g., the group data, the policy data, etc.) for the changed list of group Ids; if the PCF receives the changed group data, for example, included in the policy data or application data, the PCF does not need to retrieve the UDR for group data.

Furthermore, as may be understood, similar to the FIG. 2, after retrieving or receiving the application data, the PCF may change the policy data in SMF/AMF accordingly.

FIG. 4 is a schematic signaling chart showing the messages for parameter provisioning controlled by UDM. Similar to FIG. 2, the PCF may subscribe to the AMF/SMF about the application group change (e.g., change in the list of the internal group Ids for the UE and for the PDU session) in advance.

Furthermore, similar to FIG. 2, the network function such as AMF and/or SMF may subscribe to UDM notifications of UE and/or Group Subscription data updates, as shown in the step 0 and message Nudm_SDM_Subscribe request.

Furthermore, the AF may initiate service configuration for services like IPTV, Background Data Transfer (BDT) or for Service Parameter Configuration, as shown in the step 0. Besides invoking the specific service (e.g. Nnef_BDTPNegotiation), the AF invokes the Nnef_ParameterProvisioning service to manage the membership for one or more groups, as shown in the following step 1.

Step 1. The AF may invoke a request message for parameter provisioning, i.e., Nnef_ParameterProvisioning_Create/Update/Delete, to the NEF. In the Nnef_ParameterProvisioning_Create/Update/Delete message, the AF may include at least one of the following parameters: the External Group Id, the group membership, and the AF service (e.g. BDTPNegotiation).

The External Group Id identifies the group. The group membership includes the list of GPSIs that belong to the group. The AF service indicates the service and the AF using this group (e.g. AF1, BDTPNegotiation). In one embodiment, the service and the AF may ensure uniqueness in the external group identifier. In another embodiment, the group membership and/or the AF service are optional parameters.

As may be understood, the AF may selectively transmit the Nnef_ParameterProvisioning_Create/Update/Delete message. For example, the AF may request to create a new application group, by sending the Nnef_ParameterProvisioning_Create message to the NEF; the AF may request to update application data for an existing application group, by sending the Nnef_ParameterProvisioning_Update message to the NEF; and the AF may request to delete an existing application group (i.e., deleting the group membership information), by sending the Nnef_ParameterProvisioning_Delete message to the NEF.

In one embodiment, one example of the Nnef_ParameterProvisioning_Create/Update/Delete is shown in the following table 4.

TABLE 4
an example of the definition of type 5GlanParameters within Nnef_ParameterProvisioning service

| Attribute name | Data type | P | \|Cardinality | Description | Applicability |
|---|---|---|---|---|---|
| exterGroupId | ExternalGroupId | M | 1 | Identifies an 5G Virtual Network Group or | |
| | | | | an Application Group when feature | |
| | | | | ApplicationGroup is supported. | |
| Gpsis | map(Gpsi) | M | 1 . . . N | Represents the list of 5G VN Group or | |
| | | | | application group members, each | |
| | | | | member is identified by GPSI | |
| appServ | ApplicationService | O | 0 . . . 1 | Represents the application service that | ApplicationGroup |
| | | | | uses the group defined by the | |
| | | | | “externalGroupId” attribute and whose | |
| | | | | membership is represented by “gpsis” | |
| | | | | attribute. | |
| Dnn | Dnn | M | 1 | DNN for the 5G VN group, a full DNN | |
| | | | | with both the Network Identifier and | |
| | | | | Operator Identifier, or a DNN with the | |
| | | | | Network Identifier only. | |
| aaalpv4Addr | Ipv4Addr | O | 1 | Identifies the DN-AAA server IPv4 | |
| | | | | address provided by AF, for the | |
| | | | | secondary authentication/authorization | |
| | | | | and/or UE IP address allocation by | |
| | | | | DN-AAA server. | |
| aaalpv6Addr | Ipv6Addr | O | 1 | Identifies the DN-AAA server IPv6 | |
| | | | | address provided by AF, for the | |
| | | | | secondary authentication/authorization | |
| | | | | and/or UE IP address allocation by | |
| | | | | DN-AAA server. | |
| aaaUsgs | array(AaaUsage) | O | 1 . . . 2 | Identifies the usage needs for secondary | |
| | | | | authentication/authorization and/or UE IP | |
| | | | | address allocation from the DN-AAA | |
| | | | | server. | |
| Snssai | Snssai | M | 1 | S-NSSAI for the 5G VN group | |
| sessionType | PduSession Type | M | 1 | PDU Session Type allowed for 5G VN | |
| | | | | group. | |
| appDesps | map(AppDescriptor) | M | 1 . . . N | Describes the operation systems and the | |
| | | | | corresponding applications for each | |
| | | | | operation systems. The key of map is | |
| | | | | osId. | |

In the above table 4, the information element “exterGroupId” may indicate the external group Id of the application group; the optional information element “gpsis” may indicate the group membership of the application group; the optional information element “appServ” may indicate the AF service shared by the UEs in the application groups.

In another embodiment, the Definition of type 5GVnGroupConfiguration may be modified for reusing in the Nnef_ParameterProvisioning_Create/Update/Delete, as shown in the following table 5.

TABLE 5
an example of the definition of type 5GVnGroupConfiguration

| Attribute name | Data type | P | Cardinality | Description |
|---|---|---|---|---|
| 5gVnGroupData | 5GVnGroupData | C | 0 . . . 1 | Data of the 5G VN Group; may be absent in |
| | | | | modification requests; shall be present otherwise |
| members | array(Gpsi) | C | 1 . . . N | List of group members; may be absent in modification |
| | | | | requests; shall be present in creation requests |
| appServ | ApplicationService | O | 0 . . . 1 | Represents the application service that uses the |
| | | | | group defined by the “externalGroupId” attribute and |
| | | | | whose membership is represented by “gpsis” |
| | | | | attribute. |
| referenceId | ReferenceId | C | 1 | Transaction Reference ID; shall be absent in |
| | | | | modification requests; shall be present otherwise. |
| afInstanceId | NfInstanceId | C | 1 | NF Instance Id of the originating AF; shall be absent |
| | | | | in modification requests; shall be present otherwise. |
| internalGroupIdentifier | GroupId | C | 0 . . . 1 | Allocated by the UDR; shall be present in successful |
| | | | | PUT and GET responses on Nudr; otherwise shall be |
| | | | | absent. |

In the above table 5, the information element “appServ” may indicate the AF service shared by the UEs in the application groups; which may also indicate that this group is an application group, rather than a 5G VN group. In addition, the information element “5gVnGroupData” may be reused to indicate the external group Id of the application group; the optional information element “members” may be used to indicate the group membership of the application group.

In one embodiment, one example of the type of the application service is shown in the following table 6.

TABLE 6
an example of Enumeration Application Service

| Enumeration value | Description |
|---|---|
| IPTV | IPTV service |
| APPLIED_BDT | Applied Background Data Transfer for future |
| | PDU sessions |
| AF_INF_TRAFF_ROUT | AF influence on traffic routing |
| PARAM_PROV | Parameter Provisioning |
| V2X | Vehicle to everything services |

For the NEF side, after receiving the request message for parameter provisioning from the AF, the NEF checks whether the requestor is allowed to perform the requested service operation by checking requestor's identifier (i.e., AF ID). The NEF checks if the groups for the indicated AF Id are controlled by UDM (e.g. based on pre-configured information, and e.g. the domain information contained in the external group identifier, the received AF service).

Step 2. If the AF is authorised by the NEF to provision the group membership parameters and the groups for the indicated AF Id are controlled by UDM, the NEF requests to create, update and store, or delete the provisioned group membership information as part of the subscriber data via Nudm_ParameterProvision_Create/Update/Delete Request message, the message includes the group membership information and NEF reference ID.

As may be understood, the above example tables 4-6 for the Nnef_ParameterProvisioning_Create/Update/Delete message may also be applicable to the Nudm_ParameterProvision_Create/Update/Delete message.

On the other hand, if the AF is not authorized for provision of the parameters, then the NEF continues in step 5 indicating the reason to failure in Nnef_ParameterProvisioning_Create/Update/Delete Response message. In this case, the step 6 and step 7 will not be performed.

Step 3. The UDM may read from UDR, by means of Nudr_DM_Query, corresponding subscription information in order to validate required data updates and authorize these changes for this subscriber or Group for the corresponding AF.

If the AF is authorized by the UDM for provision of group membership, the UDM determines if a new internal group needs to be created (e.g. based on pre-configured information, and the domain information of the external group identifier and the AF service):
If it is so, the UDM shall assign a unique Internal Group ID for the group and include the newly assigned Internal Group ID in the Nudr_DM_Create Request message to the UDR,
Otherwise, the UDM shall include the matched Internal Group ID in the Nudr_DM_Create/Update Request message to the UDR.

The UDM also includes the received group members (GPSIs) in the Nudr_DM_Create/Update request.

The UDM resolves the GPSI to SUPI, and requests to create, update or delete the list of internal group Ids as part of the subscriber data via Nudr_DM_Create/Update/Delete Request message. Here, the verb “resolve” means the conversion between the formation. For example, both the GPSI and SUPI are the identifiers of subscriber, and the UDM may convert or translate the identifiers of subscriber from for example GPSI and SUPI.

If the list of group members is changed the UDM updates the UE subscription data according to the AF/NEF request.

UDR stores the provisioned data as part of the UE and/or Group subscription data and responds with Nudr_DM_Create/Update/Delete Response message.

In one embodiment, one example of the type of GroupIdentifiers resource in the Nudr_DM message is shown in the following table 7.

TABLE 7
an example of Definition of type GroupIdentifiers

| Attribute name | Data type | P | Cardinality | Description |
|---|---|---|---|---|
| extGroupId | ExtGroupId | C | 0 . . . 1 | This IE shall contain the External Group ID associated to the |
| | | | | provided Internal Group ID. |
| intGroupId | GroupId | C | 0 . . . 1 | This IE shall contain the Internal Group ID associated to the |
| | | | | provided External Group ID.. |
| appServ | ApplicationService | O | 0 . . . 1 | Represents the application service that uses the group defined |
| | | | | by the “extGroupId” attribute and whose membership is |
| | | | | represented by “ueIdList” attribute. |
| ueIdList | array(UeId) | C | 1 . . . N | This IE shall contain a list of the UE identifiers that belong to |
| | | | | the provided Internal/External Group ID if they are required. |

In the table 7, the GroupIdentifiers resource is in addition updated to become a document resource which can be dynamically managed by UDM (though this update will be part of the adaptation of the GroupIdentifiers resource to the standard definition for the dynamic management of 5G VN Groups). As a result, a new PUT method is defined, whose resource URI contains the extGroupId, i.e., Resource URI: {apiRoot}/nudm-sdm/<apiVersion>/group-data/group-identifiers/{extGroupId}.

On the other hand, if the AF is not authorised for provision of the parameters, then the UDM continues in step 4 indicating the reason to failure in Nudm_ParameterProvision_Update Response message. In this case, the step 6 and step 7 will not be performed.

Step 4. The UDM responds the request with Nudm_ParameterProvision_Create/Update/Delete Response. If the procedure failed, the cause value indicates the reason.

Step 5. The NEF responds the request with Nnef_ParameterProvision_Create/Update/Delete Response. If the procedure failed, the cause value indicates the reason.

Step 6. The UDM notifies the subscribed network function (e.g. AMF) of the updated UE and/or Group subscription data via Nudm_SDM_Notification Notify message.

As may be understood, the network function such as AMF and/or SMF may subscribe to Group Subscription data changes from UDM in this step 0 and be notified of Group Subscription data updates in step 6 by using the Shared Data feature defined in 3GPP TS 29.503 [52].

As may be understood, step 6 is a conditional step occurs only after successful step 3, and if there is a change in the list of internal group Ids.

Step 7. The notified network function such as AMF and/or SMF notifies the PCF about changes in the list of Group Ids. In one embodiment, the step 7 may be implemented according to the messages between the AMF/SMF, PCF, and UDR as shown and described in combination with FIG. 2; thus the details of step 7 is omitted here.

FIG. 5 is a schematic signaling chart showing the messages for parameter provisioning controlled by NEF.

Similar to FIG. 3, the PCF may subscribe to the UDR about the application group change (e.g., change in the list of the internal group Ids for the UE and for the PDU session, Policy Data, and/or Application Data changes) in advance, as shown in the step 0 and message Nudr_DataRepository_Subscribe request.

Furthermore, the AF may initiate service configuration for services like IPTV, Background Data Transfer (BDT) or for Service Parameter Configuration, as shown in the step 0. Besides invoking the specific service (e.g. Nnef_BDTPNegotiation), the AF invokes the Nnef_ParameterProvisioning service to manage the membership for one or more groups, as shown in the following step 1.

Step 1. The AF may invoke a request message for parameter provisioning, i.e., Nnef_ParameterProvisioning_Create/Update/Delete, to the NEF. In the Nnef_ParameterProvisioning_Create/Update/Delete message, the AF may include at least one of the following parameters: the External Group Id, the group membership, and the AF service (e.g. BDTPNegotiation).

As may be understood, the configuration (e.g., tables 4-6) of the Nnef_ParameterProvisioning_Create/Update/Delete message in FIG. 4 may also be applicable here.

For the NEF side, after receiving the request message for parameter provisioning from the AF, the NEF checks whether the requestor is allowed to perform the requested service operation by checking requestor's identifier (i.e. AF ID). The NEF determines that the indicated groups are not controlled by UDM, but by NEF (e.g. the AF is authorized to handle its own groups for Application Dataprovisioning for the indicated AF service, or information contained in External Group identifier, as the domain name, etc.).

If the AF is authorized by the NEF for provision of the group membership parameters, the NEF requests to create, update and store, or delete the provisioned group membership information as part of the Application Data and Policy Data subresources in the UDR.

If the AF is not authorized for provision of the parameters, then the NEF continues in step 4 indicating the reason to failure in Nnef_ParameterProvisioning_Create/Update/Delete Response message. In this case, the step 5 and step 6 will not be performed.

If the AF is authorized by the NEF and if a new group is created, the NEF may assign a unique Internal Group ID for the group and may include the newly assigned Internal Group ID in the Nudr_DM_Create Request message sent to the Application Data resource together with the provided list of external identifiers.

If the list of group members is changed, the NEF updates the corresponding policy data for the UE according to the AF/NEF request.

Step 2. For each of the external Ids provided for the group, the NEF resolves the GPSI to SUPI (interfacing UDM), and requests to create, update or delete the list of group Ids as part of the policy data for the UE via Nudr_DM_Create/Update/Delete Request message.

Step 3. the NEF stores Group data (membership, Group Id and AF service) within Application Data data via Nudr_DM_Create/Update/Delete Response message.

In one embodiment, one example of the type of GroupIdentifiers resource in Application Data Set in the Nudr_DM message is shown in the following table 8.

TABLE 8
an example of Definition of type GroupIdentifiers

| Attribute name | Data type | P | Cardinality | Description |
|---|---|---|---|---|
| extGroupId | ExtGroupId | C | 0 . . . 1 | This IE shall contain the External Group ID associated to the |
| | | | | provided Internal Group ID. |
| intGroupId | GroupId | C | 0 . . . 1 | This IE shall contain the Internal Group ID associated to the |
| | | | | provided External Group ID.. |
| appServ | ApplicationService | O | 0 . . . 1 | Represents the application service that uses the group defined |
| | | | | by the “extGroupId” attribute and whose membership is |
| | | | | represented by “ueIdList” attribute. |
| ueIdList | array(UeId) | C | 1 . . . N | This IE shall contain a list of the UE identifiers that belong to |
| | | | | the provided Internal/External Group ID if they are required. |

Resource URI for the above Application Data Set may be: {apiRoot}/nudr-dr/<apiVersion>/application-data/GroupIdentifiers.

The group identifiers resource is a document resource, where the individual resources are created via PUT method, whose resource URI is as described below:

Resource URI: {apiRoot}/nudr-dr/<apiVersion>/application-data/GroupIdentifiers/{Group Id};

where the {GroupId} represents the external group identifier indicated by the AF application.

The body of the HTTP PUT request is represented by the GroupIdentifiers resource, as shown in table 8.

Step 4. The NEF responds the request with Nnef_PolicyProvisioning_Create/Update/Delete Response. If the procedure failed, the cause value indicates the reason.

Step 5. The UDR notifies the subscribed PCF of the updated policy data (updated list of Internal Group Ids) for the UE via Nudr_DataRepository_Notification Notify message.

As may be understood, step 5 is a conditional step occurs only after successful step 2.

In one embodiment, the step 5 may be implemented according to the messages between the PCF and UDR as shown and described in combination with step 2 of FIG. 3; thus the details of step 5 is omitted here.

Step 6. The notified PCF notifies the NFs (e.g. SMF and/or AMF) about policy changes.

In one embodiment, the step 6 may be implemented according to the messages between the PCF and AMF/SMF as shown and described in combination with step 4 of FIG. 2; thus the details of step 6 is omitted here.

As shown in the above FIG. 2-5, the following concepts are proposed in the embodiments of this disclosure:
(1) PCF receiving notifications of list of group Id changes from AMF/SMF via PCRT GROUP_CHANGE;
(2) AF indication of group membership to the NEF (for any AF service);
(3) UDM controlling the group membership for a group (other than 5G VN group), upon request from the NEF;
(4) NEF controlling the group membership for application specific groups, upon explicit request from the AF, in details:
   a. Optionally, NEF allocating an internal group Id;
   b. NEF storing in UDR (Application Data) the information of the new group: External Group Id, Internal Group Id, Group membership;
   c. NEF updating the list of group Ids in SM Policy Data, AM Policy Data, UE Policy Data as applicable.

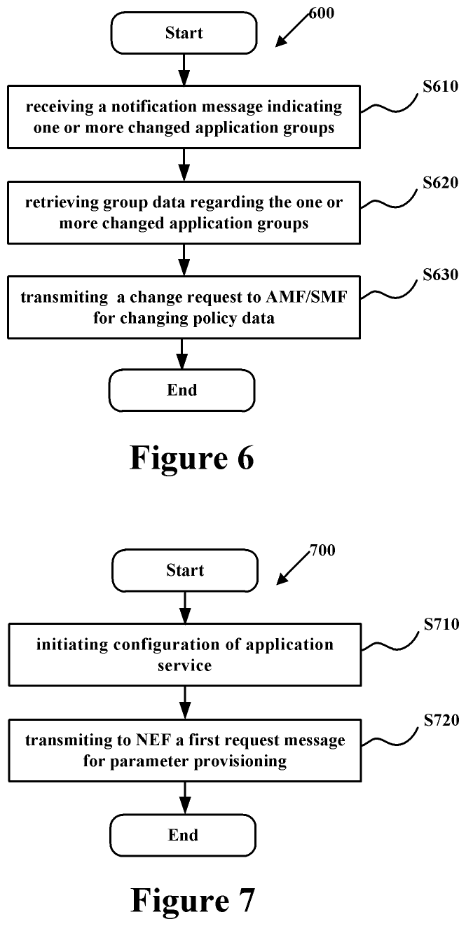

FIG. 6 is a schematic flow chart showing an example method in a network implementing a policy control function, according to the embodiments herein. In one or more embodiments, the flow chart in FIG. 6 can be implemented in the Policy Control Function (PCF) in FIGS. 2-5.

The method 600 may begin with step S610, in which the PCF may receive, from a network function implementing a terminal management function and/or a network function implementing a data repository function, a notification message indicating one or more changed application groups, wherein the notification message comprises one or more internal group identifiers each of which identifies respective one of the one or more changed application groups.

In one embodiment, the notification message may further comprise a policy control request trigger indicating that there is a change in the one or more application groups.

Then, the method 600 may proceed to step S620, in which the PCF may transmit, to the network function implementing the data repository function, a query request for retrieving group data regarding the one or more changed application groups based on the one or more internal group identifiers.

In one embodiment, the notification message may further comprise group data regarding the one or more changed application groups.

Subsequently, the method 600 may proceed to step S630, in which the PCF may transmit, to the network function implementing the terminal management function, a change request for changing policy data based on the group data for the one or more UEs in the application group, to change UE policy or Session Management policy or Access and Mobility policy.

In one embodiment, the application group may comprise one or more User Equipments, UEs, sharing the same application service.

In one embodiment, the PCF may change the policy data for the one or more UE by: deleting, from the network function implementing the terminal management function, the policy data corresponding to one or more application groups removed for the UE; creating, in the network function implementing the terminal management function, the policy data corresponding to one or more groups added for the UE; and updating, in the network function implementing the terminal management function, the policy data corresponding to one or more groups updated for the UE.

In one embodiment, the PCF may also transmit, to the network function implementing the terminal management function, a first subscription request for subscribing one or more internal group identifiers of the one or more changed application groups.

In one embodiment, the PCF may also transmit, to the network function implementing the data repository function, a second subscription request for subscribing one or more internal group identifiers or group data of the one or more changed application groups. In one embodiment, the one or more application services comprises at least one of IPTV service; applied background data transfer for future Package Data Unit (PDU) sessions; AF influence on traffic routing; parameter provisioning; and vehicle to everything (V2X) services.

In one embodiment, the communication system can be fifth generation system (5GS). In one embodiment, the network function implementing the policy control function is Policy Control Function (PCF); the network function implementing the terminal management function is Session Management Function (SMF), or Access and Mobility Management Function (AMF) or a UE policy delivery management function together with a terminal function, or User Plane Function (UPF); or the network function implementing the data repository function is Unified Data Repository (UDR).

The above steps are only examples, and the network function implementing the policy control function can perform any actions related to the PCF described in connection with FIGS. 2-5, to handle dynamic group membership for an application group in a mobile communication system.

FIG. 7 is a schematic flow chart showing an example method in a network implementing an application function, according to the embodiments herein. In one or more embodiments, the flow chart in FIG. 7 can be implemented in the Application Function (AF) in FIGS. 4-5.

The method 700 may begin with step S710, in which the AF may initiate configuration of application service to manage the application group.

Then, the method 700 may proceed to step S720, in which the AF may transmit, to a network function implementing a network exposure function, a first request message for parameter provisioning, wherein the first request message comprises one or more external group identifiers each of which identifies an application group, and one or more first indicators each of which indicating an application service used by the application group.

In one embodiment, the first request message may further comprise one or more second indicators each of which indicating one or more members in the application group.

In one embodiment, the parameter provisioning may include at least of the following actions: delete, create, and update.

In one embodiment, the one or more application services may comprise at least one of IPTV service; applied background data transfer for future Package Data Unit (PDU) sessions; AF influence on traffic routing; parameter provisioning; and vehicle to everything (V2X) services.

In one embodiment, the communication system can be fifth generation system (5GS). In one embodiment, the network function implementing the network exposure function is Network Exposure Function (NEF); or the network function implementing the application function is Application Function (AF).

The above steps are only examples, and the network function implementing the application function can perform any actions related to AF described in connection with FIGS. 4-5, to handle dynamic group membership for an application group in a mobile communication system.

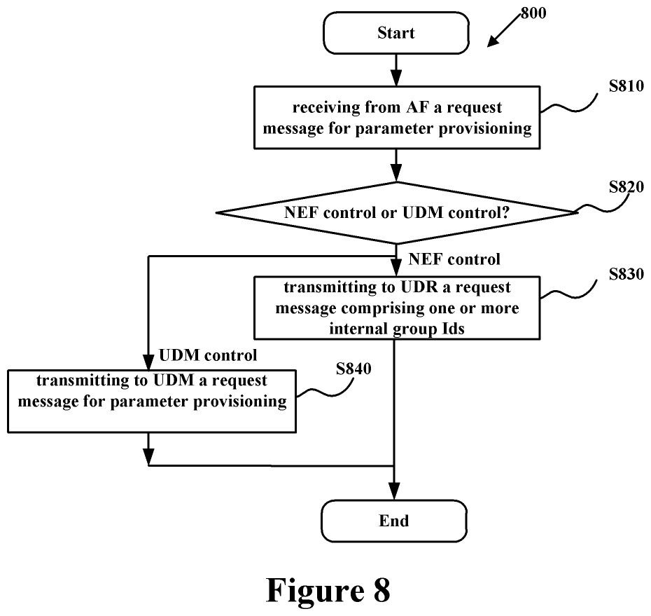

FIG. 8 is a schematic flow chart showing an example method in a network implementing a network exposure function, according to the embodiments herein. In one or more embodiments, the flow chart in FIG. 8 can be implemented in the Network Exposure Function (NEF) in FIGS. 4-5.

The method 800 may begin with step S810, in which the NEF may receive, from a network function implementing an application function, a first request message for parameter provisioning, wherein the first request message comprises one or more external group identifiers each of which identifies an application group, and one or more first indicators each of which indicating an application service used by the application group.

In one embodiment, the parameter provisioning may include at least of the following actions: delete, create, and update.

In one embodiment, the first request messages may further comprise: one or more second indicators each of which indicating one or more members in the application group.

Then, the method 800 may proceed to step S820, in which the NEF may determine whether the application group is controlled by the network function implementing the network exposure function, or by a network function implementing a data management function.

In one embodiment, whether the application group is controlled by the network function implementing the network exposure function, or by a network function implementing a data management function is determined based on the one or more first indicators.

Then, in response to the determination that the application group is controlled by the network function implementing the network exposure function, the method 800 may proceed to step S830, in which the NEF may transmitting, to a network function implementing a data repository function, a second request message, wherein the second request message comprises one or more internal group identifiers corresponding to the one or more external group identifiers respectively.

In one embodiment, the application group is controlled by the network function implementing the data management function; and wherein the one or more application services comprises at least: parameter provisioning.

Subsequently, in response to the determination that the application group is controlled by the network function implementing the data management function, the method 800 may proceed to step S840, in which the NEF transmitting, to the network function implementing the data management function, a third request message for parameter provisioning, wherein the third request message comprises the one or more external group identifiers and the one or more first indicators.

In one embodiment, the third request messages may further comprise: one or more second indicators each of which indicating one or more members in the application group.

In one embodiment, the application group is controlled by the network function implementing the network exposure function; and the one or more application services comprises at least one of IPTV service; applied background data transfer for future Package Data Unit (PDU) sessions; AF influence on traffic routing; and vehicle to everything (V2X) services Referring back to S830, the NEF may assign an internal group identifier to be transmitted together with the one or more internal group identifier to the network function implementing the data repository function, in response to determining that an application group is to be created.

In one embodiment, in the step S830, the NEF may also update a list of the one or more internal group identifiers in policy data, in response to a change in the one or more application group based on one or more external group identifiers.

In one embodiment, in the step S830, the NEF may also resolve the one or more external group identifiers to the corresponding one or more internal group identifiers respectively.

In one embodiment, in the step S830, the NEF may also resolve the second indicator including a list of Generic Public Subscription Identifier (GPSI), as a list of Subscription Permanent Identifier (SUPI).

In one embodiment, in the step S830, the NEF may store group data associated with the one or more application group into the network function implementing the data repository function.

In one embodiment, at least one of the following parameters in the group data are to be stored in the network function implementing the data repository function: the one or more external group identifiers; the one or more internal group identifiers; the one or more first indicators; and the one or more second indicators.

In one embodiment, the communication system can be fifth generation system (5GS). In one embodiment, the network function implementing the network exposure function is Network Exposure Function (NEF); the network function implementing the application function is Application Function (AF); the network function implementing the data management function is Unified Data Management (UDM); or the network function implementing the data repository function is Unified Data Repository (UDR).

The above steps are only examples, and the network function implementing the network exposure function can perform any actions related to NEF described in connection with FIGS. 4-5, to handle dynamic group membership for an application group in a mobile communication system.

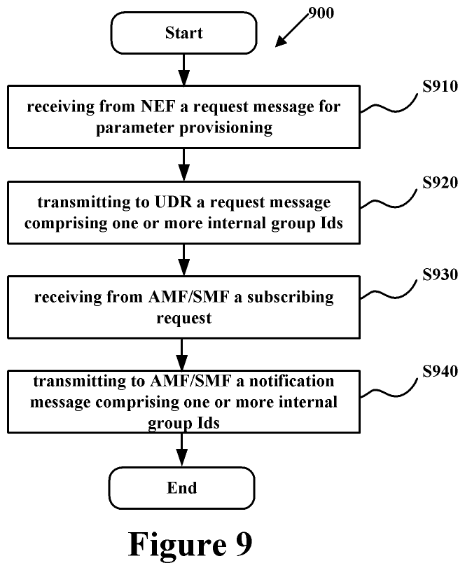

FIG. 9 is a schematic flow chart showing an example method in a network implementing a data management function, according to the embodiments herein. In one or more embodiments, the flow chart in FIG. 9 can be implemented in the Unified Data Management (UDM) in FIGS. 2 and 4.

The method 900 may begin with step S910, in which the UDM may receive, from a network function implementing a network exposure function, a first request message for parameter provisioning, wherein the first request message comprises one or more external group identifiers each of which identifies an application group, and one or more first indicators each of which indicating an application services used by the application group.

In one embodiment, the first request message may further comprise one or more second indicators each of which indicating one or more members in the application group.

In one embodiment, the one or more application services may comprise at least: parameter provisioning.

Then, the method 900 may proceed to step S920, in which the UDM may transmit, to a network function implementing a data repository function, a second request message, wherein the second request message comprises one or more internal group identifiers corresponding to the one or more external group identifiers respectively.

In one embodiment, in the step S920, the UDM may assign an internal group identifier to be transmitted together with the one or more internal group identifier to the network function implementing the data repository function.

In one embodiment, in the step S920, the UDM may also update a list of the one or more internal group identifiers in policy data, in response to an update in the one or more application group based on one or more external group identifiers.

In one embodiment, in the step S920, the UDM may also resolve the one or more external group identifiers to the corresponding one or more internal group identifiers respectively.

In one embodiment, in the step S920, the UDM may also resolve the second indicator including a list of Generic Public Subscription Identifier (GPSI), as a list of Subscription Permanent Identifier (SUPI).

In one embodiment, in the step S920, the UDM may store group data associated with the one or more application group into the network function implementing the data repository function.

In one embodiment, at least one of the following parameters in the group data are to be stored in the network function implementing the data repository function: the one or more external group identifiers; the one or more internal group identifiers; the one or more first indicators; and the one or more second indicators.

Subsequently, the method 900 may proceed to step S930, in which the UDM may receive, from a network function implementing a terminal management function, a subscription request for subscribing changes in the one or more application group.

Subsequently, the method 900 may proceed to step S940, in which the UDM may transmit, to the network function implementing the terminal management function, a notification message comprising one or more internal group identifiers each of which identifies respective one of the one or more changed application groups.

In one embodiment, the communication system can be fifth generation system (5GS). In one embodiment, the network function implementing the network exposure function is Network Exposure Function (NEF); the network function implementing the terminal management function is Session Management Function (SMF), or Access and Mobility Management Function (AMF) or a UE policy delivery management function together with a terminal function, or User Plane Function (UPF); the network function implementing the data management function is Unified Data Management (UDM); or the network function implementing the data repository function is Unified Data Repository (UDR).

The above steps are only examples, and the network function implementing the data management function can perform any actions related to UDM described in connection with FIGS. 2 and 4, to handle dynamic group membership for an application group in a mobile communication system.

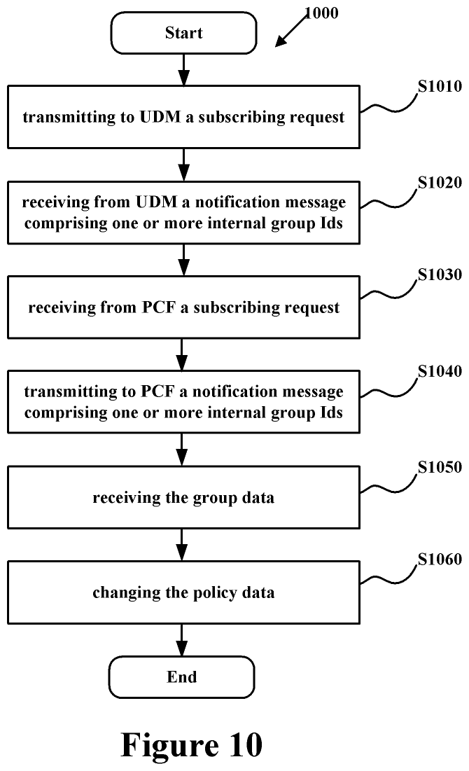

FIG. 10 is a schematic flow chart showing an example method in a network implementing a terminal management function, according to the embodiments herein. In one or more embodiments, the flow chart in FIG. 10 can be implemented in the Network Function (e.g., AMF/SMF) in FIGS. 2-5.

The method 1000 may begin with step S1010, in which the AMF/SMF may transmit, to a network function implementing a data management function, a subscribing request for subscribing changes in one or more internal group identifiers.

Then, the method 1000 may proceed to step S1020, in which the AMF/SMF may receive, from the network function implementing the data management function, a notification message comprising one or more internal group identifiers each of which identifies respective one of the one or more changed application groups.

Subsequently, the method 1000 may proceed to step S1030, in which the AMF/SMF may receive, from a network function implementing a policy control function, a subscribing request for subscribing changes in one or more internal group identifiers.

Subsequently, the method 1000 may proceed to step S1040, in which the AMF/SMF may transmit, to the network function implementing the policy control function, a further notification message comprising one or more internal group identifiers each of which identifies respective one of the one or more changed application groups.

In one embodiment, the further notification message further comprises a policy control request trigger indicating that there is a change in the one or more internal group identifiers each of which identifies respective one of the one or more changed application groups.

In one embodiment, the one or more application services comprise at least one of parameter provisioning.

Subsequently, the method 1000 may proceed to step S1050, in which the AMF/SMF may receive, from the network function implementing the policy control function, the group data for the one or more UE in the application group.

Subsequently, the method 1000 may proceed to step S1060, in which the AMF/SMF may change the policy data based on the application group data, to change UE policy or Session Management policy or Access and Mobility policy, wherein the application group comprising one or more User Equipment (UE), sharing the same application service.

In one embodiment, changing the policy data for the one or more UE comprising at least one of: deleting, from the network function implementing the terminal management function, the policy data corresponding to one or more application groups removed for the UE; creating, in the network function implementing the terminal management function, the policy data corresponding to one or more groups added for the UE; and updating, in the network function implementing the terminal management function, the policy data corresponding to one or more groups updated for the UE.

In one embodiment, the communication system can be fifth generation system (5GS). In one embodiment, the network function implementing the policy control function is Policy Control Function (PCF); the network function implementing the terminal management function is Session Management Function (SMF), or Access and Mobility Management Function (AMF) or a UE policy delivery management function together with a terminal function, or User Plane Function (UPF); the network function implementing the data management function is Unified Data Management (UDM); or the network function implementing the data repository function is Unified Data Repository (UDR).

The above steps are only examples, and the network function implementing the terminal management function can perform any actions related to AMF/SMF described in connection with FIGS. 2-5, to handle dynamic group membership for an application group in a mobile communication system.

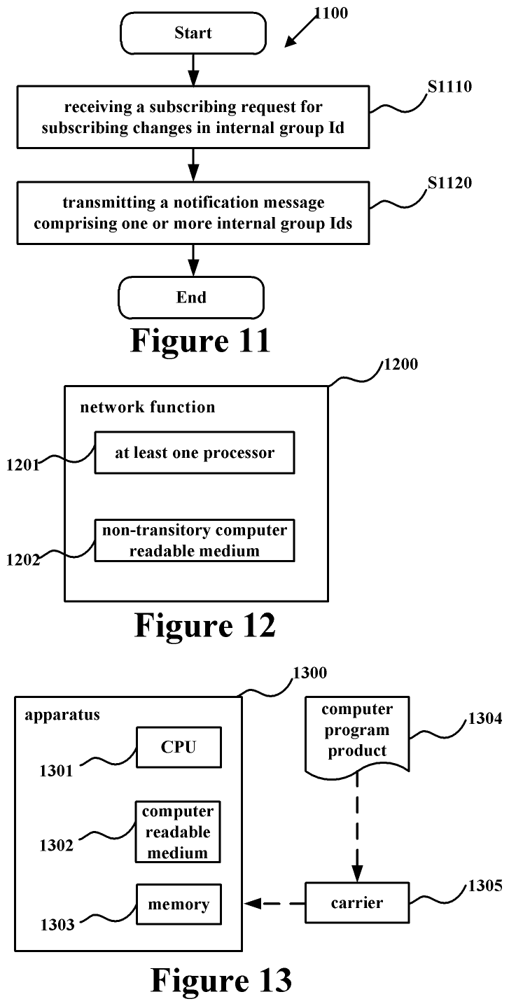

FIG. 11 is a schematic flow chart showing an example method in a network implementing a data repository function, according to the embodiments herein. In one or more embodiments, the flow chart in FIG. 11 can be implemented in the Unified Data Repository (UDR) in FIGS. 2-5.

The method 1100 may begin with step S1110, in which the UDR may receive, from a network function implementing a policy control function, a subscribing request for subscribing changes in one or more internal group identifiers.

Then, the method 1100 may proceed to step S1120, in which the UDR may transmit, to the network function implementing the policy control function, a notification message comprising one or more internal group identifiers each of which identifies respective one of the one or more changed application groups.

In one embodiment, the notification message may comprise application group data regarding the one or more changed internal group identifiers each of which identifies respective one of the one or more changed application groups.

In one embodiment, the one or more application services may comprise at least one of IPTV service; applied background data transfer for future Package Data Unit (PDU) sessions; AF influence on traffic routing; parameter provisioning; and vehicle to everything (V2X) services.

In one embodiment, the communication system can be fifth generation system (5GS). In one embodiment, the network function implementing the policy control function is Policy Control Function (PCF); or the network function implementing the data repository function is Unified Data Repository (UDR).

The above steps are only examples, and the network function implementing the data repository function can perform any actions related to UDR described in connection with FIGS. 2-5, to handle dynamic group membership for an application group in a mobile communication system.

FIG. 12 is a schematic block diagram showing an example network function, according to the embodiments herein.

In one embodiment, the network function 1200 may include at least one processor 1201; and a non-transitory computer readable medium 1202 coupled to the at least one processor 1201. The non-transitory computer readable medium 1202 contains instructions executable by the at least one processor 1201, whereby the at least one processor 1201 is configured to perform the steps in the example methods 600, 700, 800, 900, 1000 and 1100 as shown in the schematic flow chart of FIGS. 6-11; the details thereof is omitted here.

Note that, the network function can be implemented as hardware, software, firmware and any combination thereof. For example, the network function may include a plurality of units, circuities, modules or the like, each of which can be used to perform one or more step of the example methods 600, 700, 800, 900, 1000, 1100 or one or more step shown in FIGS. 2-5 related to any network function, such as AF, PCF, NEF, SMF/AMF, UDM, UDR, etc.

FIG. 13 is a schematic block diagram showing an example computer-implemented apparatus 1300, according to the embodiments herein. In one embodiment, the apparatus 1300 can be configured as the above mentioned function or node, such as AF, PCF, AMF, SMF, NEF, UDM, UDR, and etc.

In one embodiment, the apparatus 1300 may include but not limited to at least one processor such as Central Processing Unit (CPU) 1301, a computer-readable medium 1302, and a memory 1303. The memory 1303 may comprise a volatile (e.g. Random Access Memory, RAM) and/or non-volatile memory (e.g. a hard disk or flash memory). In one embodiment, the computer-readable medium 1302 may be configured to store a computer program and/or instructions, which, when executed by the processor 1301, causes the processor 1301 to carry out any of the above mentioned methods.

In one embodiment, the computer-readable medium 1302 (such as non-transitory computer readable medium) may be stored in the memory 1303. In another embodiment, the computer program can be stored in a remote location for example computer program product 1304 (also can be embodied as computer-readable medium), and accessible by the processor 1301 via for example carrier 1305.

The computer-readable medium 1302 and/or the computer program product 1304 can be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

In general, various exemplary embodiments can be implemented in hardware or special purpose circuits, software, logic, or any combination thereof. For example, some aspects may be implemented in hardware, while other aspects may be implemented in firmware or software executable by a controller, microprocessor or other computing devices, although the disclosure is not limited thereto. Although various aspects of the exemplary embodiments of the present disclosure may be shown and described as a block diagram, a flowchart, or some other graphical representation, it should be well understood that, by way of non-limiting example, the blocks, devices, systems, techniques, or methods described herein may be implemented in hardware, software, firmware, special purpose circuits or logic, general purpose hardware or controllers, or other computing devices, or some combinations thereof.

As such, it should be understood that at least some aspects of the exemplary embodiments of the present disclosure may be practiced in various components such as integrated circuit chips and modules. Accordingly, it should be appreciated that the exemplary embodiments of the present disclosure can be implemented in an apparatus embodied as an integrated circuit, which can include circuits (and possibly firmware) for embodying at least one or more of a data processor, a digital signal processor, a baseband circuit, and a radio frequency circuit configurable to operate in accordance with an exemplary embodiment of the present disclosure.

It should be understood that at least some aspects of the exemplary embodiments of the present disclosure may be embodied in computer-executable instructions executed by one or more computers or other devices, such as embodied in one or more program modules. Generally, program modules include routines, programs, objects, components, data structures, and the like that perform particular tasks or implement particular abstract data types when executed by a processor in a computer or other devices. The computer executable instructions may be stored on a computer readable medium such as a hard disk, an optical disk, a removable storage medium, a solid state memory, a random access memory (RAM), and the like. Those skilled in the art will appreciate that the functionality of the program modules can be combined or distributed as desired in various embodiments. Additionally, the functions may be embodied as a whole or partly in a firmware or hardware equivalents such as integrated circuits, field programmable gate arrays (FPGAs), and the like.

The present disclosure includes any novel feature or a combination of features disclosed herein either explicitly or in any generalized form. Various modifications and adaptations to the above described embodiments of the present disclosure will become apparent to those skilled in the art in light of the above description when read in conjunction with the drawings. However, any and all modifications will still fall within the scope of the non-limiting and exemplary embodiments of the disclosure.

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

| Abbreviation | Explanation |
|---|---|
| 3GPP | 3rd Generation Partnership Project |
| 5GS | the 5th Generation System |
| AF | Application Function |
| AMF | Access and Mobility Management Function |
| API | Application Programming Interface. |
| AUSF | Authentication Server Function |
| DNN | Data Network Name |
| EPC | Evolved Packet Core |
| EPS | Evolved Packet System |
| GPSI | Generic Public Subscription Identifier |
| NEF | Network Exposure Function |
| NF | Network Function |
| NRF | Network Registration Function |
| NSSF | Network Slice Selection Function |
| PCC | Policy and Charging Control |
| PCF | Policy Control Function |
| PDU | Packet Data Unit |
| QoS | Quality of Service |
| SMF | Session Management Function |
| S-NSSAI | Single Network Slice Selection Assistance |
| | Information |
| SUPI | Subscription Permanent Identifier |
| UDM | Unified Data Management |
| UDR | Unified Data Repository |
| UPF | User Plane Function |
| VN | Virtual Network. |

1-51. (canceled)

52. A method performed by a first network function implementing a policy control function, comprising:
receiving, from at least one of a second network function implementing a terminal management function and a third network function implementing a data repository function, a first notification message indicating one or more changed application groups, wherein the first notification message comprises one or more internal group identifiers each of which identifies respective one of the one or more changed application groups,
characterized in that, the application group comprising one or more User Equipments, UEs, sharing the same application service, and
wherein one or more members of the one or more changed application groups are changed.

53. The method according to claim 52, wherein the first notification message further comprises a policy control request trigger indicating that there is a change in the one or more application groups.

54. The method according to claim 52, further comprising:
transmitting, to the third network function implementing the data repository function, a query request for retrieving group data regarding the one or more changed application groups based on the one or more internal group identifiers.

55. The method according to claim 52, wherein the first notification message comprises group data regarding the one or more changed application groups.

56. The method according to claim 54, the method further comprising:
transmitting, to the second network function implementing the terminal management function, a change request for changing policy data based on the group data for the one or more UEs in the application group, to change UE policy or Session Management policy or Access and Mobility policy.

57. The method according to claim 55, the method further comprising:
transmitting, to the second network function implementing the terminal management function, a change request for changing policy data based on the group data for the one or more UEs in the application group, to change UE policy or Session Management policy or Access and Mobility policy.

58. The method according to claim 52, further comprising:
transmitting, to the second network function implementing the terminal management function, a first subscription request for subscribing one or more internal group identifiers of the one or more changed application groups.

59. The method according to claim 52, further comprising:
transmitting, to the third network function implementing the data repository function, a second subscription request for subscribing one or more internal group identifiers or group data of the one or more changed application groups.

60. The method according to claim 52, wherein the one or more application services comprises at least one of:
IPTV service;
applied background data transfer for future Package Data Unit, PDU, sessions;
AF influence on traffic routing;
parameter provisioning; and
vehicle to everything, V2X, services.

61. The method according to claim 52, wherein:
the first network function implementing the policy control function is Policy Control Function, PCF;
the second network function implementing the terminal management function is Session Management Function, SMF, or Access and Mobility Management Function, AMF; or
the third network function implementing the data repository function is Unified Data Repository, UDR.

62. A method performed by a second network function implementing a terminal management function, comprising:
receiving, from a first network function implementing a policy control function, a first subscribing request for subscribing changes in one or more internal group identifiers; and
transmitting, to the first network function implementing the policy control function, a first notification message comprising one or more internal group identifiers each of which identifies respective one of the one or more changed application groups,
characterized in that, the application group comprising one or more User Equipments, UEs, sharing the same application service, and
wherein one or more members of the one or more changed application groups are changed.

63. The method according to claim 62, wherein the first notification message further comprises a policy control request trigger indicating that there is a change in the one or more internal group identifiers each of which identifies respective one of the one or more changed application groups.

64. The method according to claim 62, wherein the one or more application services comprises at least one of:
parameter provisioning.

65. The method according to claim 62, further comprising:
transmitting, to a sixth network function implementing a data management function, a third subscribing request for subscribing changes in one or more internal group identifiers; and
receiving, from the sixth network function implementing the data management function, a second notification message comprising one or more internal group identifiers each of which identifies respective one of the one or more changed application groups.

66. The method according to claim 62, further comprising:
receiving, from the first network function implementing the policy control function, the group data for the one or more UE in the application group; and
changing the policy data based on the application group data, to change UE policy or Session Management policy or Access and Mobility policy.

67. The method according to claim 66, wherein changing the policy data for the one or more UE comprising at least one of:
deleting, from the second network function implementing the terminal management function, the policy data corresponding to one or more application groups removed for the UE;
creating, in the second network function implementing the terminal management function, the policy data corresponding to one or more groups added for the UE; and
updating, in the second network function implementing the terminal management function, the policy data corresponding to one or more groups updated for the UE.

68. The method according to claim 62, wherein:
the first network function implementing the policy control function is Policy Control Function, PCF;
the second network function implementing the terminal management function is Session Management Function, SMF or Access and Mobility Management Function, AMF;
the sixth network function implementing the data management function is Unified Data Management, UDM; or
the third network function implementing the data repository function is Unified Data Repository, UDR.

69. A first network function implementing a policy control function, comprising:
at least one processor; and
a non-transitory computer readable medium coupled to the at least one processor, the non-transitory computer readable medium contains instructions executable by the at least one processor, characterized in that, the at least one processor is configured to perform following steps:
receiving, from at least one of a second network function implementing a terminal management function and a third network function implementing a data repository function, a first notification message indicating one or more changed application groups, wherein the first notification message comprises one or more internal group identifiers each of which identifies respective one of the one or more changed application groups,
characterized in that, the application group comprising one or more User Equipments, UEs, sharing the same application service, and
wherein one or more members of the one or more changed application groups are changed.

70. The first network function according to claim 69, wherein the first notification message further comprises a policy control request trigger indicating that there is a change in the one or more application groups.

71. The first network function according to claim 69, wherein the at least one processor is further configured to perform following step:
transmitting, to the third network function implementing the data repository function, a query request for retrieving group data regarding the one or more changed application groups based on the one or more internal group identifiers.
